(19) United States
(12) Patent Application Publication
(10) Pub. No.: US 2004/0005253 A1
(43) Pub. Date: Jan. 8, 2004

(54) Liquid barrier and methods of using the same

(76) Inventors: Timothy A. Martin, Newnan, GA (US); Michael A. Clendening, Newnan, GA (US); Thomas H. Ramsey, Peachtree City, GA (US)

Correspondence Address: PENNIE & EDMONDS LLP, 1667 K STREET NW, SUITE 1000, WASHINGTON, DC, 20006

(21) Appl. No.: 10/428,030

(22) Filed: May 2, 2003

Related U.S. Application Data
(60) Provisional application No. 60/377,212, filed on May 3, 2002.

(51) Int. Cl. B01J 19/08; C02F 1/78

(52) U.S. Cl. 422/186.07; 210/198.1; 210/760

(57) ABSTRACT

A liquid barrier is disclosed that comprises a porous hydrophobic material which allows the flow of gases (e.g., corrosive gases) but inhibits the flow of liquids, including aqueous liquids. A specific embodiment of the invention relates to a venturi which incorporates a liquid barrier that allows the flow of gases (e.g., ozone and air) but inhibits the flow of liquids. Another specific embodiment of the invention relates to an ozone generation system that includes an ozone generator and a liquid barrier made of a porous hydrophobic material, which allows the flow of ozone but inhibits the flow back of liquids to the ozone generator. The invention also encompasses methods of introducing a gas into an aqueous liquid, wherein the gas passes through a liquid barrier prior to being introduced into the aqueous liquid.

This application claims priority to application Ser. No. 60/377,212, the entirety of which is incorporated herein by reference.

### 1. FIELD OF THE INVENTION

This invention relates to liquid barriers, or check valves, and methods of their use.

### 2. BACKGROUND OF THE INVENTION

Check valves are fluid flow regulating devices that allow fluid flow in one direction and prevent its flow in the opposite direction. Typically, check valves utilize a mechanical system actuated by pressure. When in the open position, fluids are allowed to flow freely through the system. When the fluid flow in the system is reversed, however, the reversed flow operates to close the check valve, preventing further flow in that direction. Check valves are commonly used in fluid systems where it is advantageous to maintain a single fluid flow direction. The use of mechanical check valves in such systems is limited by the environment in which they must function. In systems containing corrosive materials or particulate matter, mechanical check valves often fail due to corrosion, insufficient sealing, or clogging. Mechanical check valves are also position sensitive. If a mechanical check valve is inadvertently installed in the wrong direction, fluids will flow when the system should be closed or the system will be closed when fluids should be flowing.

In two-phase systems, the term “check valve” is often used to refer to what is more accurately called a liquid barrier. An example of a two-phase system in which a liquid barrier is used is a system wherein one of the phases is a liquid and the other phase is a gas. Generally the liquid phase is aqueous. Liquid barriers are generally used in such systems to prevent the liquid phase from entering a section of the system where only the gas phase is desirable.

In recent years, ozonation has become a popular method of disinfecting and oxidizing water borne contaminates. Ozonation is used as a means of disinfection in agriculture, agriculture, aquariums, water-bottling plants, breweries, wineries, swimming pools, cooling towers, dairies, food processing plants, grocery produce displays, lakes, ponds, fountains, laundries, drinking water systems, spas, and waste water systems. Because ozone is not readily found in nature nor efficiently stored or transported, it is typically made in situ with ozone generators. These ozone generators create ozone from oxygen in the air, where it is then transferred to the water to be purified. Typical ozone generators create ozone by passing air containing oxygen over a high voltage electric current. As a result, the oxygen becomes highly excited, and in this excited state, recombines with other oxygen atoms to form ozone. This process also produces nitrogen oxide as a byproduct.

In order to maximize effectiveness of ozone as an oxidizer, the transfer of ozone into the water must be optimized. A common method of transferring ozone from an ozone generator to water requiring treatment involves the use of a venturi within a section of piping. Venturi injection systems employ the vacuum created at the outlet of a venturi to transfer ozone gas into the water. The water requiring treatment is pumped through a small orifice of the venturi, creating an area of high pressure on the inlet side of the venturi and a lower pressure area on the outlet side. Ozone is fed into the system at a port on the outlet side of the venturi. The low pressure region at the outlet side of the venturi creates a vacuum, which pulls the ozone enriched air and byproduct gasses from the ozone generator through the port into the water. Another method of transferring ozone from an ozone generator uses a direct pressure system. In a direct pressure system, a pump is used to force ozone out of the ozone generator and into the water to be treated.

Regardless of how ozone is transferred to the water in need of purification, it must be done in a fashion that prevents water from entering the ozone generator. This is because high voltage electrical currents are typically used to create ozone and presence of water inside the generator can short it out or otherwise cause its failure. Unfortunately, in a typical venturi-based system, blockage of the output line of an ozone generator (e.g., the output line in a spa pump) can allow water to enter the venture orifice and thus into the ozone generator supply line. Without any means to prevent backflow, this water can enter the ozone generator. Water may also enter the ozone generator when the liquid phase of the system is not flowing. For example, if the ozone generator is installed at a height below the surface of the water source, the head height of the water source will cause water to flow back into the ozone generator. A need therefore exists for check valves or other means of preventing such occurrences.

Because of the corrosive nature of ozone, nitrogen oxide, and particulate matter present in the ozonation systems, mechanical check valves used in such systems often fail without warning. This is because their mechanical components cannot stand up to the corrosive environment of the ozonation process. Unfortunately, their failure typically goes unnoticed until the liquid pump is turned off, or the output line is blocked. Even when mechanical check valves are manufactured with ozone resistant materials, the mechanical components may still fail, creating an opening for water to enter the ozone generator. Thus, there exists a need for a liquid barrier, or check valve, that can withstand the highly corrosive environment characteristic of ozone generation.

### 3. SUMMARY OF THE INVENTION

This invention relates to a liquid barrier that comprises a porous hydrophobic material that allows the flow of gasses (e.g., ozone and air) but inhibits the flow of liquids, including aqueous liquids. The hydrophobic porous material of the liquid barrier is fixed within a housing which has a first and a second opening. A specific embodiment of the invention encompasses a venturi which incorporates a liquid barrier that allows the flow of gasses but inhibits the flow of liquids. Another specific embodiment of the invention encompasses an ozone generation system that includes an ozone generator and a liquid barrier made of a porous hydrophobic material, which allows the flow of ozone but inhibits the flow back of liquids to the ozone generator.

This invention also encompasses a method of introducing a gas (e.g., ozone) into a liquid (e.g., an aqueous liquid), wherein the gas passes through a liquid barrier before being introduced into the liquid. The invention further encompasses a method of protecting a gas generation device from exposure to a liquid, wherein the gas passes through a liquid barrier prior to being introduced into the liquid.

### 3.1. BRIEF DESCRIPTION OF THE FIGURES

Specific embodiments of the invention can be understood with reference to the attached figures, described below:

FIG. 1 shows a cut-away perspective, as well as a front and a perspective view, of a liquid barrier of the invention.

FIG. 2 shows a venturi that incorporates a liquid barrier at the inlet of the gas stream.

FIG. 3 shows a common plumbing setup for an ozone generation system, such as that in a spa, which incorporates a liquid barrier of the invention.

FIG. 4 shows a common plumbing setup for an ozone generation system, which uses a pump to inject ozone into the liquid, and which incorporates a liquid barrier of the invention.

FIG. 5 shows a system in which a pressurized container is used to inject gas into a liquid stream that incorporates a liquid barrier of the invention.

### 4. DETAILED DESCRIPTION OF THE INVENTION

This invention is based on a discovery that certain hydrophobic porous materials can be used to provide liquid barriers, or check valves, that are non mechanical (i.e., free of moving parts) and operable under a variety of oxidative and corrosive conditions. Because liquid barriers of this invention can function in a variety of environments, they can be used in any number of systems, apparatuses, and processes including, but not limited to, gas induction systems and disinfection processes that use strong oxidizers such as ozone.

Porous liquid barriers of this invention can be assembled by fixing a porous hydrophobic material inside a housing having a first and second opening. The hydrophobic material inhibits the passage of aqueous liquid though the valve, while at the same time allowing the passage of gasses, such as air and ozone.

A specific embodiment of the invention includes a housing with a hydrophobic porous material and a self-sealing porous material fixed to the housing. The hydrophobic porous material performs as described above by preventing liquids from flowing through the pores of the liquid barrier, while allowing the gas to freely flow through the pores. The self-sealing porous material is positioned on the gaseous side of the hydrophobic porous material. Gas is able to readily pass through the self-sealing porous material, but if the hydrophobic porous material were to fail and liquids were allowed to pass through the gaseous side of the hydrophobic porous material, the self sealing porous material would seal itself upon contact with liquids. The self-sealing porous material upon sealing does not allow any fluid flow, effectively halting all fluid transfer. This feature provides a fail-safe mechanism that further prevents any material from flowing back through the check valve.

### 4.1 POROUS MATERIAL

The hydrophobic porous material of the present invention can be made of a fluoropolymer, including, but not limited to, polytetrafluoroethylene (PTFE); polyvinylidene fluoride (PVDF); polyvinyl fluoride (PVF); perfluoroalkoxy (PFA); polychlorotrifluoroethylene (PCTFE); copolymers, such as tetrafluoroethylenehexafluoropropylene (TFE-HFP); tetrafluoroethylene-ethylene (ETFE) and ethylene-chlorotrifluoroethylene (ECTFE); and fluoroelastomers. The hydrophobic porous material can also be made of a metal resistant to oxidative corrosion (e.g., stainless steel, titanium or a combination thereof) and a fluoropolymer. Other materials that can be used include polyolefins (including, but not limited to, polyethylene, polypropylene, polyvinyl chloride (PVC), polystyrene and polymethyl-methacrylate (PMMA)), polyesters, polyurethanes, polycarbonates, polyetheretherketone (PEEK), polyphenylene oxides (PPO), polyether sulfones (PES), and combinations thereof.

In a preferred embodiment of the invention, the porous hydrophobic material is a fluoropolymer. A specific preferred fluoropolymer is polytetrafluoroethylene. In a particular embodiment, the porous hydrophobic material is billeted, skived, and sintered.

Porous materials from which porous liquid barriers can be made are insoluble in water and contain one or more channels through which gas molecules can pass but would prevent the flow of liquids. Porous materials can be made by any method known to those skilled in the art, including, but not limited to: sintering; the use of blowing agents and/or leaching agents; microcell formation methods such as those disclosed by U.S. Pat. Nos. 4,473,665 and 5,160,674, both of which are incorporated herein by reference; drilling, including laser drilling; and reverse phase precipitation. Depending on how it is made, a porous material can thus contain regular arrangements of channels of random or well-defined diameters and/or randomly situated pores of varying shapes and sizes. Pore sizes are typically referred to in terms of their average diameters, even though the pores themselves are not necessarily spherical.

The particular method used to form the pores or channels of a porous material and the resulting porosity (i.e., average pore size and pore density) of the porous material can vary according to the desired application for which the final porous liquid barrier will be used. For example, small diameter pores or channels are preferred in cases where there are increased liquid pressures, while larger diameter pores or channels may be preferred in cases where smaller liquid pressures are present. The desired porosity of the material can also affect the material itself, as porosity can affect in different ways the physical properties (e.g., tensile strength and durability) of different materials.

A specific porous material of this invention has an average pore size of less than about 40 μm, 30 μm, or 20 μm, 10 μm , or 5 μm. Mean pore size and pore density can be determined using, for example, a mercury porosimeter, scanning electron microscopy, or atomic force microscopy.

Porosity and other factors such as manufacturing cost and resistance to corrosion or decomposition are preferably considered when choosing the material(s) from which a porous material is made. The porous material is preferably made from a hydrophobic material, and may be chemically modified if necessary to increase its hydrophobicity. In specific embodiments, the thickness of the porous material is from about 25 to about 4000 microns, about 50 to about 3000 microns, or from about 100 to about 2000 microns. The porous material can be made of single-component materials, multi-component materials such as laminates, and woven and non-woven fibrous materials. Examples of fibrous materials include, but are not limited to, those made of acrylic, polyesters, polyolefins, glass, and mixtures thereof.

The porous materials of this invention preferably allow a gas flow rate of greater than about 0.05 standard cubic feet per hour (SCFH) at a vacuum of about 3.5 inches of mercury, about 0.1 SCFH at a vacuum of about 3.5 inches of mercury, or about 0.2 SCFH at a vacuum of about 3.5 inches of mercury. The water entry pressure present for each liquid barrier can vary significantly according to its use. In specific embodiments, the water entry pressure of the porous material is greater than about 0.1 psi, about 0.2 psi, or about 0.5 psi. In another specific embodiment, the surface energy of the porous material is less than about 40, 35, or 25 dynes per centimeter.

Specific hydrophobic porous materials that can be used in the liquid barriers of this invention include, but are not limited to, those disclosed in U.S. patent application Ser. No. 09/519,590, filed Mar. 6, 2000, the entirety of which is incorporated herein by reference.

In another embodiment of the invention, a porous self-sealing material is positioned after the porous hydrophobic material (i.e., between the material and the valve exit with respect to the flow direction of ozone or other gasses). Examples of self-sealing materials include, but are not limited to, those disclosed in U.S. patent application Ser. No. 09/699,364, filed Oct. 31, 2000, the entirety of which is incorporated herein by reference. Self sealing agents that may be incorporated within porous media include hydrogels. See, e.g., U.S. patent application Ser. No. 09/375,383, filed Aug. 17, 1999, the entirety of which is incorporated by reference. Materials used in the liquid barrier of the present invention should be compatible with the environment inherent to the liquid barrier's use. For example, if the liquid barrier is subjected to highly oxidative conditions, the components used in the should be able to withstand those conditions without significant decomposition for the desired time.

Factors to be considered when selecting a self-sealing material include, but are not limited to, the amount of water it can absorb, its rate of water absorption, how much it expands when it absorbs water, its solubility in, for example, solvents that may come into contact with the final self-sealing material, its thermal stability, and its chemical stability.

Antimicrobial agents can also be incorporated into the porous medium, or into one or more secondary materials positioned between the openings of the housing. Examples of antimicrobial materials and porous materials containing them include, but are not limited to, those disclosed in U.S. Pat. No. 6,551,608, the entirety of which is incorporated herein by reference.

### 4.2 TYPICAL HOUSING

The housing of the liquid barrier can be made from the same material from which the hydrophobic porous material is made, but can also be made from materials such as, but not limited to, glass and phenolic resin.

Generally, the housing can be made of any water insoluble material capable of supporting the porous material while maintaining a sufficient seal to prevent seepage between the porous material and the housing walls. One skilled in the art would be able to select a housing material based upon the requirements of the material such as corrosion resistance, thermal and oxidative resistivity, and strength. Preferred housings are capable of withstanding corrosion from various agents, including but not limited to ozone and nitrogen oxide. Specific housings are cylindrical in shape, although any shape that could contain a porous material may be used. The housing materials should be of sufficient thickness and strength to withstand the pressures generated by the system with minimal deformation. One skilled in the art would know to select housing materials that are compatible with the porous materials (e.g., having similar thermal expansion, similar corrosion resistance). The housing could also be coated with material to increase its resistance to corrosive and thermal effects, as well as to aid in the ability to bind with other materials.

The porous material can be fixed to the housing using any means known in the art, including, but not limited to ultrasonically welding; welding; threaded assembly; heat staking; adhesives; RF welding; insert molding; interference fit; mechanical fasteners, such as screws and bolts; and combinations thereof The method of fixing the porous material to the housing is dependent upon the selected materials used for construction and their physical properties, the environment for which it should be used, and other factors that would be apparent to one of ordinary skill in the art.

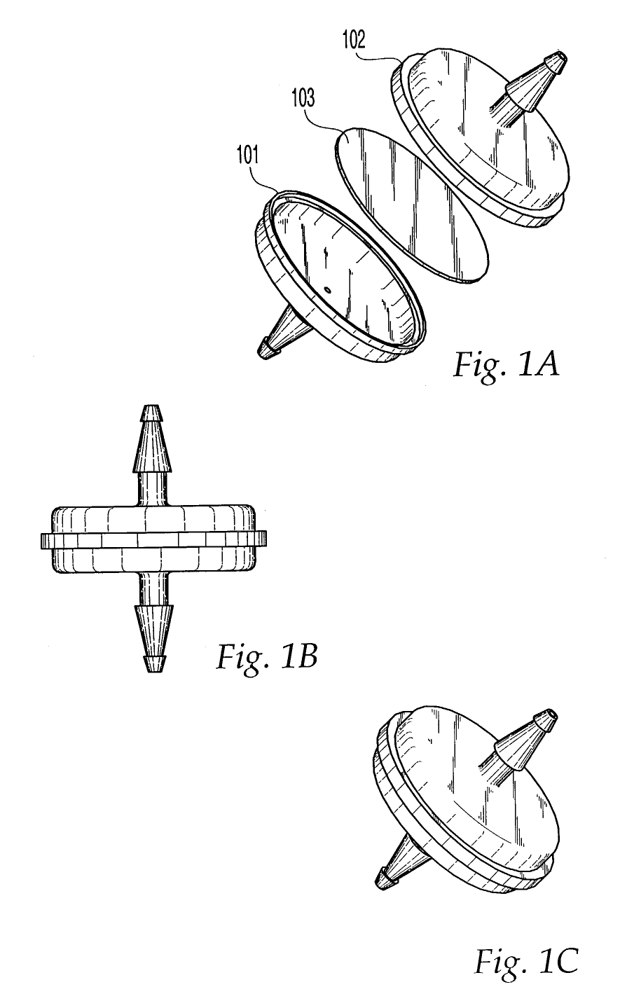

FIG. 1 shows a cut-away perspective of the liquid barrier of the invention, as well as a front and isometric view. The cut-away perspective, as shown in FIG. 1A shows hydrophobic porous material 103 fixed between the two sections of the housing, 101 and 102. Each section of the housing has an opening. FIG. 1B shows the liquid barrier of the invention in a front view. FIG. 1C shows the liquid barrier of the invention in an isometric view.

### 4.3 GAS INJECTION SYSTEM

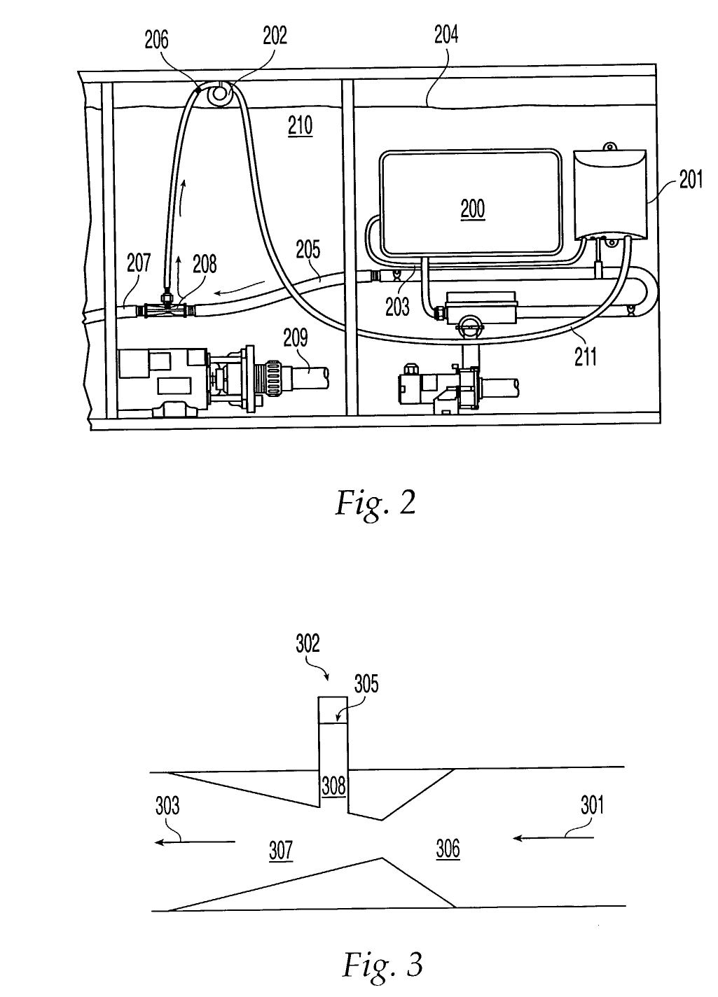

FIG. 2 shows a gas injection system that incorporates a liquid barrier vent at the inlet of the gas stream. In this system, liquid 201 requiring gas injection is pumped through a small orifice at the inlet of the venturi 206. Passage through this orifice creates an area of high pressure on the inlet side 206 of the venturi and an area of lower pressure on the outlet side 207. The low pressure region at the outlet side of the venturi creates a vacuum, which pulls the gas 202 through a liquid barrier 205 and through a port 208 on the outlet side of the venturi. The gas is introduced into the liquid stream in this manner. The liquid barrier 305 allows the gas to flow through but prevents liquid from flowing back into the gas injection system where it could cause damage.

### 4.4 OZONE GENERATION SYSTEM

FIG. 3 illustrates the use of a liquid barrier in a common plumbing setup for a home spa, which uses ozone generation to disinfect the bathing water. An ozone generator 301 produces ozone, which is transferred to the water for disinfection via venturi 308. The water is pumped through tubing 311 into the inlet side of the venturi, where it creates an area of high pressure at the point upstream of the constriction in the throat of the venturi. The water exiting this constriction is of a greatly reduced pressure, and this pressure drop creates a vacuum to aspirate the ozone/air mixture into the water. The turbulence created by the action of the venturi assists in mixing the ozone with the water in line 307.

A blockage in line 307 could cause the water to flow upstream through line 305 toward the ozone generator. As previously discussed, the presence of water in the ozone generator could be catastrophic to the system. To prevent such a problem, a liquid barrier 303 can be placed in several locations in the system. One such place is downstream of tubing loop 302, the apex of which is preferably located above the spa water line 304 to ensure that the head pressure of the spa water will not force water into the ozone generator. A liquid barrier placed in this location prevents the backflow of water due to blockage of line 307. The liquid barrier can also be placed just upstream of the venturi in line 305 or just downstream of the ozone generator 301.

### 4.5 PRESSURIZED GAS SYSTEMS

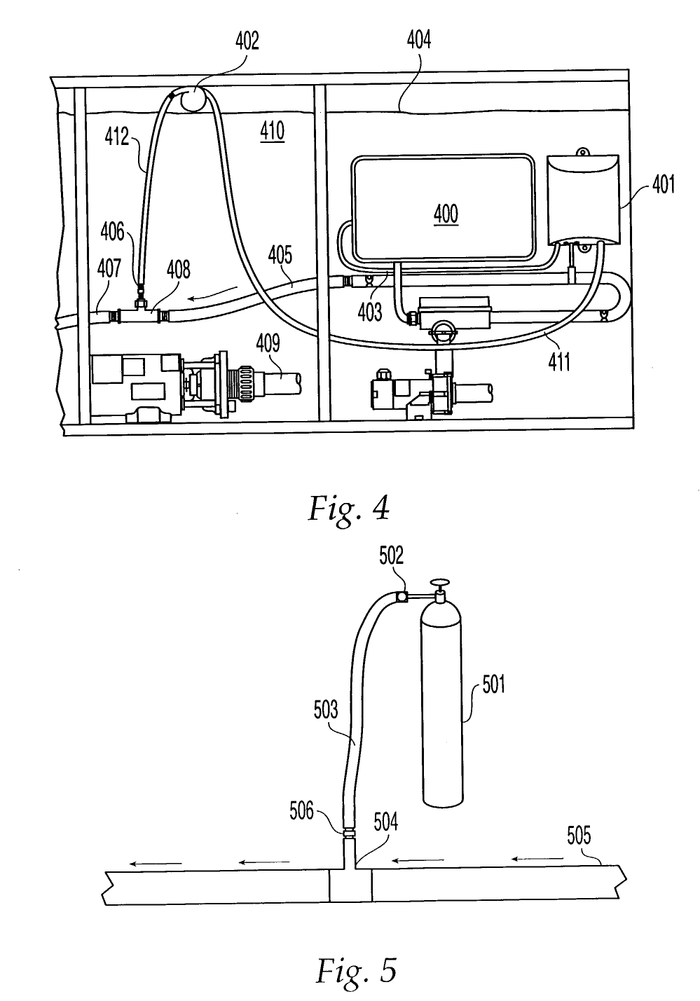

FIG. 4 illustrates the use of a liquid barrier in a common plumbing system which uses a pump to pressurize ozone into the liquid. An ozone generator 401 produces ozone, which is transferred to the liquid stream (e.g., a water stream) in line 411 via pump 402. Pump 402 can also be a compressor or a fan. The pressurized ozone is discharged through the liquid barrier 406, which is located upstream of tee 408. The ozone is injected into the liquid stream water under pressure from pump 402 at tee 408.

A blockage in line 407 could cause the liquid to flow upstream toward pump 402 and ozone generator 401. As previously discussed, the presence of liquid in the ozone generator could be catastrophic to the system. To prevent such a problem, liquid barrier 406 can be placed in several locations in the system. In a preferred embodiment, liquid barrier 406 is located at the union of the pump discharge line 412 and tee 504.

FIG. 5 illustrates a pressurized system that incorporates a liquid barrier at the inlet of the gas stream. In this system, a pressurized container 501 (e.g, a compressed gas cylinder) is used to force pressurized gas (e.g., ozone) through flexible line 503 into liquid stream 505 (e.g., a water stream). The pressurized gas passes through liquid barrier 506 before entering liquid stream 505 at tee 504. The liquid barrier 506 can be located anywhere along flexible line 503, though in a preferred embodiment it is located at the union of flexible line 503 and tee 504. Liquid barrier 506 allows passage of the pressurized gas stream but prevents back flow of the liquid stream through flexible line 503 and into pressurized container 501.

The full scope of the invention is better understood with reference to the attached claims.

What is claimed is:

1. A liquid barrier comprising a housing with a first opening and a second opening, and a porous hydrophobic material disposed between the first and second openings such that gas flowing from the first opening to the second opening must pass through the porous hydrophobic material.

2. The liquid barrier of claim 1, wherein the porous hydrophobic material is made of a fluoropolymer.

3. The liquid barrier of claim 2, wherein the fluoropolymer is polytetrafluoroethylene.

4. The liquid barrier of claim 1, wherein the porous hydrophobic material is sintered.

5. The liquid barrier of claim 1, further comprising a self-sealing porous material.

6. The liquid barrier of claim 1, wherein the porous hydrophobic material comprises an antimicrobial additive.

7. The liquid barrier of claim 1, wherein the mean pore size of the porous hydrophobic material is less than about 40 microns.

8. The liquid barrier of claim 1, wherein the porous hydrophobic material has a water entry pressure greater than about 0.1 psi.

9. The liquid barrier of claim 1, wherein the liquid barrier allows an air flow rate greater than about 0.05 standard cubic feet per hour at about 3.5 inches of mercury vacuum.

10. A gas injection system comprising:
an inlet for a liquid stream;
an outlet for the liquid stream;
an inlet for a gas stream; and
a liquid barrier made of porous hydrophobic material through which a gas stream can pass;
wherein the liquid barrier is located upstream of the inlet for the gas stream.

11. The gas injection system of claim 10, wherein the mean pore size of the porous hydrophic material is less than about 40 microns.

12. The gas injection system of claim 10, wherein the porous hydrophobic material has a water entry pressure greater than about 0.1 psi.

13. The gas injection system of claim 10, wherein the liquid barrier allows an air flow rate greater than about 0.05 standard cubic feet per hour at about 3.5 inches of mercury vacuum.

14. An ozone generation system comprising:
an ozone generator having an outlet; and
a liquid barrier made of a porous hydrophobic material through which ozone can pass;
wherein ozone from the generator outlet is passed through the liquid barrier.

15. The ozone generation system of claim 14, wherein the mean pore size of the porous hydrophic material is less than about 40 microns.

16. The ozone generation system of claim 14 wherein the porous hydrophobic material has a water entry pressure greater than about 0.1 psi.

17. The ozone generation system of claim 14 wherein the liquid barrier allows an air flow rate greater than about 0.05 standard cubic feet per hour at about 3.5 inches of mercury vacuum.

18. A method of introducing a gas into an aqueous liquid, which comprises connecting the output of a gas generation device to the first opening of the liquid barrier of claim 1, and connecting the second opening of the liquid barrier to a source of aqueous liquid.

19. A method of protecting a gas generation device from exposure to an aqueous liquid, which comprises connecting the output of a gas generation device to the first opening of the liquid barrier of claim 1, and connecting the second opening of the liquid barrier to a source of aqueous liquid.
